(19) United States
(12) Patent Application Publication
(10) Pub. No.: US 2026/0367247 A1
(43) Pub. Date: Nov. 19, 2026

(54) System for mapping and selecting waste in waterways and method for mapping and selecting waste in waterways using said system

(71) Applicant: Rivercleaning Srls Unipersonale, Cassola (VI) (IT)

(72) Inventor: Vanni Covolo, Cassola (VI) (IT)

(21) Appl. No.: 19/477,780

(22) PCT Filed: Apr. 23, 2024
(86) PCT No.: PCT/IB2024/053944

§ 371 Date: Oct. 23, 2025

(30) Foreign Application Priority Data
Apr. 27, 2023 (IT) 102023000008301

(51) Int. Cl. G01S 15/88; G01S 15/86; G06V 20/05

(52) U.S. Cl. CPC G01S 15/88; G01S 15/86; G06V 20/05

(57) ABSTRACT

A system for selecting waste in waterways includes at least two detector devices configured to detect objects carried by the waterway and at least one processing unit in communication with the detector devices. The processing unit is configured to receive the collected data, process it and identify the presence of waste and the type of detected waste, if any.

The present patent concerns methods and systems for cleaning waterways, and in particular it concerns a new system for detecting, identifying and collecting waste in waterways in order to prevent pollution of the aquatic environment while at the same time mapping waste. The present patent also concerns the method for using the system for mapping waste in a waterway, identifying said waste and removing it or part of it, if necessary.

It is known that different types of materials are transported by rivers, some organic such as branches and leaves, and some inorganic such as plastic, glass, cans and waste produced by man in general.

Different types of barriers have been recently implemented, whose ultimate aim is to collect the material floating on the surface and bring it to a collection point.

A problem often arising with this type of barriers lies in that the collected material may even mostly consist of branches, leaves and organic material, which should be preferably left in the river as this material is naturally part of its ecosystem.

The known solutions currently consist of systems that collect all the material present in the rivers, indistinctly, postponing the selection and sorting of the collected waste to a later moment.

However, in many countries, once the material has been collected from the river, it is considered waste and must be disposed of as such, and it is not possible to sort and separate it in order to reintroduce it in the river.

In this way, therefore, the river is indeed cleaned, but also deprived of natural material which is necessary for its ecosystem, and consequently impoverished.

For example, document CN 108 082 405 A describes a watercraft equipped with an arm suited to collect waste from water, and an on-board waste identification system, which divides the mass of collected material, initially into two types of waste, natural and artificial, and then into sub-categories, so as to sort the waste for subsequent recycling and disposal. However, this type of equipment does not allow the waste to be detected and identified while it is still in the water. This results in the drawback that waste must necessarily be brought on board for identification and, according to the legislation in force in many countries around the world, this waste can no longer be put back into the water, but must be disposed of according to regulations. Therefore, with the equipment of the known type, such as the one described above, it is neither possible to map waste nor to leave plant residues in the water, which instead are essential for the ecosystem.

The subject of the present patent is a new system for detecting, identifying, sorting and if necessary collecting waste in waterways, which can not only detect waste but also identify the type of waste even before it is removed from the waterway. Following this identification process, the system makes it possible to choose which treatment to apply to said waste, that is, whether it should be diverted from the waterway for collection or removed from the waterway or, in the case of organic or plant waste, whether it should instead be left in the waterway.

The main object of the present invention is therefore to provide a system for detecting the waste carried by the waterway and identifying the type of waste, even directly in the water.

It is another object of the present invention to provide a system for selecting the waste to be taken from the waterway.

It is another object of the present invention to provide a system that is able to detect both floating waste and waste being carried below the water surface.

It is another object of the present invention to provide a system that operates autonomously, with no need for operators.

These and other direct and complementary objects are achieved by the new system for detecting, identifying and collecting waste in waterways, comprising in its main parts at least two detector devices capable of detecting and classifying waste while it is still in the water, and more specifically:
at least one sonar device and means suited to position said at least one sonar device so that it is immersed or partially immersed in the waterway to detect objects from below the water surface;
at least one camera and means suited to position said at least one camera on the water surface or immersed or partially immersed in the water to detect floating or otherwise transported objects in the waterway;
at least one processing unit that receives the data collected by said at least one sonar device and said at least one camera, processes it and identifies the presence and type of any waste detected and still present in the water.

In particular, said at least one processing unit compares the data collected by said at least one sensor and by said at least one camera with the data stored in a database, in such a way as to identify the waste detected and distinguish between at least two types of waste, that is, a first type, the so-called natural waste, consisting of plant or organic material in general such as, for example, branches, algae and leaves, and a second type, the so-called artificial waste, such as plastic objects, glass, metals, etc., of non-natural origin.

According to the invention, in combination with or as an alternative to one of said two detector devices, it is also possible to use one or more photoelectric sensors, which can always be used to identify the type of waste while it is still in the water. The new system can also comprise one or more mechanical devices suited to selectively act on the identified waste in at least two different ways:
in the case where said waste is identified as natural waste, said mechanical devices can leave it into the waterway or provide for its total or partial removal from the waterway;
in the case where said waste is identified as artificial waste, said mechanical devices move or divert said waste towards a collection area.

In a first embodiment, said mechanical devices comprise at least one device suited to remove the artificial waste from the waterway and transfer it to a collection area. Said at least one device can, for example, comprise one or more movable mechanical arms, provided with tongs and/or nets and/or members in general for removing the waste from the waterway, and is, for example, mounted on a fixed structure which in turn, for example, is constrained to the bank of the waterway or in the waterway or to a bridge on the waterway, etc.

Alternatively, said at least one device can be mounted on a moving structure, for example a watercraft navigating the waterway or another structure in any case mounted in the waterway or on its bank.

In a second embodiment, said mechanical devices comprise at least one barrier or gate arranged in the waterway, and movable between a position in which it allows the transit of the waste, if this is identified as natural waste, and a position in which it prevents the transit of the waste in order to allow it to be collected or diverts it towards a collection area, if this waste is identified as non-natural.

Said collection area can be located within the waterway and be constituted, for example, by a container, or in proximity to the bank of the waterway and be constituted, even in this case, by a container or, however, be delimited by barriers, nets or similar elements.

Said collection area can also be created as a recessed space or a dock on the river bank.

Said collection area can also be located on a watercraft, especially in the case where the entire system or said at least one collection device is mounted on the watercraft itself.

Said mechanical devices are in turn preferably controlled by said processing unit. The system can thus work autonomously, with no need for operators.

Furthermore, the system also comprises control systems suited to identify any malfunctions or blockages of said mechanical devices and/or said detector devices. For example, if said at least one barrier is blocked, this situation is detected by sensors placed on the barrier itself or elsewhere and signalled, for example by means of light and/or sound alarms or through messages sent to a terminal used by an operator, who can then intervene.

The new system for detecting, identifying, sorting and collecting waste present in a waterway can be effectively used for cleaning rivers and waterways in general, for example when placed at a river narrowing or a waste diverting barrier.

The present invention can also be effectively and practically used in combination with a waste removal system, for example of the type described in patent documents WO2022/053858A1, WO2022/029472A1, WO2020/049379A1 of the same applicant, which are cited by reference herein.

The new system for detecting, identifying, sorting and collecting the waste present in waterways is therefore an innovative and highly efficient solution for the prevention of environmental pollution, as it ensures clean waterways and the protection of the aquatic environment.

The new system can also be used to map the distribution of waste in a waterway, even without using mechanical means to handle the waste itself, which can be identified and classified without removing it from the water.

The method for mapping, identifying and if necessary removing the waste present in a waterway comprises the following steps:
setting at work said at least two detector devices, by means of which it is possible to detect the presence of any waste in the water, both deep and floating;
processing the data collected by said at least two detector devices in order to:
   a) determine how said waste is distributed in the water;
   b) identify the type of waste in the water, distinguishing at least between natural waste and artificial waste.

Therefore, as explained above, the method makes it possible to detect and identify waste while it is still in the water, so that its distribution can be mapped also for statistical or research purposes or for planning any remediation and/or prevention measures.

The method can also include the possible step of removing said artificial waste and/or said natural waste by collecting it from the waterway.

As an alternative to or in combination with the preceding removal step, the method can comprise a step during which said artificial waste and/or said natural waste is diverted.

Since the system can also be mounted on a boat, the method can be applied at several points in a waterway or basin in general.

The characteristics of the new system are better clarified in the following description, making reference to the drawings, which are attached by way of non-limiting example.

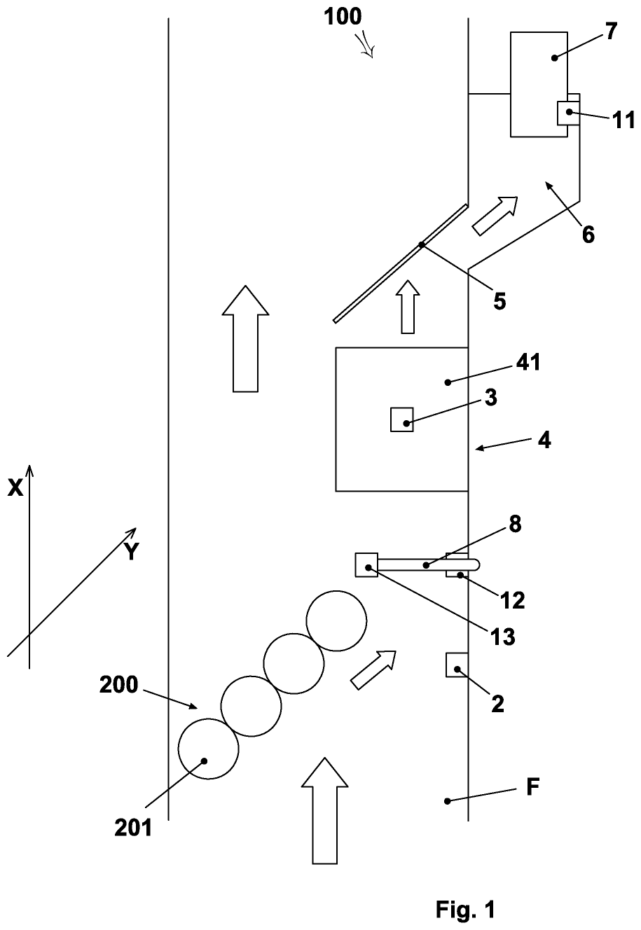

FIG. 1 shows a schematic plan view of a possible embodiment of the new system (100), installed in a waterway (F), downstream of a waste diverting system (200), for example of the type described in patent documents WO2022/053858A1, WO2022/029472A1, WO2020/049379A1 of the same applicant.

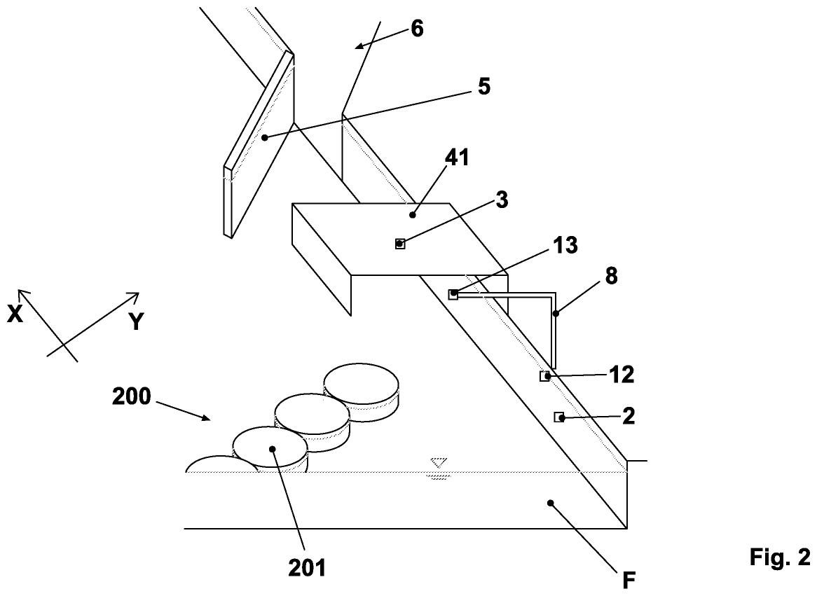

FIG. 2 shows a three-dimensional schematic view of part of the new system (100) shown in FIG. 1.

In a possible solution schematically shown in the drawings, the new system (100) comprises:
an underwater sonar device mounted on supporting means that keep said sonar device (2) at a given depth below the surface of a waterway (F) and oriented so as to analyse an area, hereinafter referred to as the first monitoring area;
at least one first camera (3), for example and preferably a black and white and/or infrared and/or structured light camera, mounted on supporting means (4) which keep said camera (3) at a given height above the surface of the waterway (F) or immersed or partially immersed. Said at least one camera (3) is oriented so as to analyse an area, hereinafter referred to as the second monitoring area. Said first and said second monitoring areas may coincide or partially overlap or not overlap at all; in a possible solution, said supporting means (4) of the camera (3) comprise a dome (41) or a surface placed above the camera (3) itself in order to protect the surface examined by the camera from the reflections of the water waves; a controlled lighting system suited to improve the detection process carried out by the cameras can be provided under said dome (41). Said dome (41) can be replaced by structures already present on the waterway, such as a bridge;
a processing unit suited to process the data received from said sonar device (2) and/or said camera (3);
means for data communication between said sonar device (2) and said processing unit and/or between said camera (3) and said processing unit; said data communication means can also allow remote and wireless communication.

According to the invention, the new system (100) can comprise one or more additional cameras (12, 13), for example but not necessarily mounted upstream of said first camera (3), oriented so as to analyse at least one area, hereinafter referred to as the third monitoring area. In turn, said third monitoring area can completely or partially coincide with said first and/or said second monitoring area, or it can be completely separate from them.

Said additional cameras (12, 13) are also mounted on supports (8) that hold them in certain positions, out of the water, immersed or partially immersed.

Also said additional cameras are connected to said processing unit, which receives data from them in relation to the acquired images and uses said data to detect the presence of waste in transit and identify the type of waste.

The system (100) preferably comprises also at least one barrier (5), placed downstream of said at least one dome (41) and movable between an intercepting position, in which it is arranged crosswise with respect to the waterway, at the level of the water surface or partially immersed, so as to intercept and divert the waste, and a transit position, in which it is raised above the water surface or completely immersed or arranged longitudinally with respect to the waterway or generically moved to a different position with respect to the waterway, so as not to prevent the transit of the waste.

In said intercepting position, said barrier is oriented and configured in such a way that the waste is pushed by the waterway itself towards a collection area (6) which is located, for example, close to the bank (F1) of the waterway (F).

According to the invention, said collection area (6) can be provided with means installed to remove the waste collected there, for example a conveyor belt (7).

In an alternative solution, as an alternative to or in combination with said barrier (5), the system (100′) comprises at least one mechanical device which, controlled by said processing unit based on the collected and processed data, picks up the waste to be removed directly from the waterway (F) or from said collection area (6).

According to the invention, at least one spectrometer (11) may be installed in or close to said collection area (6), which, by analysing the waste already detected by said sonar device (2) and/or by said cameras (3, 12, 13), identifies the type of material of which it is made. Said data can be used to carry out further or more precise sorting of the waste, that is, to verify whether it is natural or non-natural waste or to distinguish among plastic, metal, glass, etc. waste.

According to the invention, said system (100) can be installed on the river (F) downstream of a system (200) for cleaning rivers such as the one described in patent documents WO2022/053858A1, WO2022/029472A1, WO2020/049379A1 of the same applicant.

Said system (200) comprises, for example, a plurality of rotating modules (201) aligned according to a direction (Y) generically transversal with respect to the direction (X) of the waterway, equipped with blades which, rotating around an axis, for example orthogonal to the water surface, push the floating waste towards an area of the river (F), actually creating a narrowing at which said system (100) for detecting, identifying, sorting and collecting waste is installed.

According to the invention, said sonar device (2) and/or said cameras (3, 12, 13) can be oriented in such a way as to also examine the area upstream of said system (200) and to be able to detect the arrival of large organic waste or a vessel or object in general whose transit must be allowed. In this case, said processing unit can give an alarm or send a command to lift or displace said system (200) to avoid any impact with the object moving towards it.

According to the invention, said system (100) can be completely or partially installed on a watercraft. In this case, said sonar device (2) and/or one or more of said cameras (3, 12, 13) are mounted on said watercraft.

The system (100) further comprises a power supply system for the above-mentioned devices and means of communication between said barrier or said device and said processing unit; said means of communication may also allow remote and wireless communication.

According to the invention, said processing unit can use the data received from said detector devices to update the stored data and learn new strategies/conditions for the identification of the type of waste detected.

Therefore, with reference to the above description and the attached drawings, the following claims are made.

The invention claimed is:

1. A system (100) for mapping, detecting and identifying waste in a waterway, comprising:
a plurality of detector devices which include::
a sonar device (2) and means suited to position said sonar device so that said sonar device is immersed or partially immersed in the waterway in order to detect objects in the waterway, and
a camera (3, 12, 13) and supporting means (4, 8) therefor configured to position said camera (3, 12, 13) so that said camera is arranged on a water surface or immersed or partially immersed in the waterway in order to detect the objects in the waterway; and
a processing unit in communication with said detector devices,
wherein said processing unit receives the data collected by said sonar device (2) and by said camera (12, 13), processes said data, and identifies a presence of waste and a type of waste detected, if any, through comparison with a plurality of stored data, so as to distinguish at least two types of waste that include a first type of waste that is natural or organic and is constituted by plant material or organic material, and a second type of waste that is not organic and that includes objects made of plastic, glass, or metal, or other objects which are not of natural origin.

2. The system (100) according to claim 1, further comprising one or more photoelectric sensors in combination with or as an alternative to one of said detector devices.

3. The system (100) according to claim 1, further comprising one or more mechanical devices, positioned downstream of said detector devices and configured to selectively act on the identified waste in at least two different manners:
when said waste is identified as natural waste, said one or more mechanical devices leave said waste in the waterway or extract said waste or divert the waste towards at least one collection area (6); or
when said waste is identified as non-organic waste, said mechanical devices move said waste or divert said waste towards at least one collection area (6).

4. The system (100) according to claim 3, wherein said mechanical devices are controlled by said processing unit according to the data that has been collected and processed.

5. The system (100) according to claim 3, wherein said mechanical devices comprise at least one device configured to collect said second type of waste from the waterway and transfer said second type of waste in said at least one collection area (6).

6. The system (100) according to claim 5, wherein said at least one device is mounted on a structure that is constrained to a waterway bank or into the waterway or to a bridge on the waterway.

7. The system (100) according to claim 5, wherein said at least one device is mounted on a mobile structure configured to travel on the waterway or on another structure mounted in the waterway or on a bank of the waterway.

8. The system (100) according to claim 3, wherein said mechanical devices comprise at least one barrier (5) or gate arranged in the waterway and configured to be moved between a first position, in which said at least one barrier (5) or gate allows the waste to transit therethrough, and an intercepting position, in which said at least one barrier (5) or gate stops the waste to allow the waste to be collected or diverts a course of the waste towards said at least one collection area (6), according to the type of waste identified.

9. The system (100) according to claim 3, wherein said plurality of detector devices comprise at least one spectrometer (11) installed in said at least one collection area (6) and/or adjacently thereto, said at least one spectrometer being configured to detect a material of which said at least two types of waste are made.

10. The system (100) according to claim 1, further comprising control systems to identify and signal any malfunctions or anomalies.

11. The system (100) according to claim 1, further comprising communication means for remote and wireless communication between said processing unit and said plurality of detector devices and said mechanical devices.

12. The system (100) according to claim 1, wherein said supporting means (4) of said camera (3) comprise a dome (41) or a surface placed on top of the camera (3) and configured to protect a surface examined by the camera from sunlight.

13. The system (100) according to claim 3, further comprising, installed upstream of said plurality of detector devices, a second system (200) comprising a plurality of rotating modules (201) aligned in a transverse direction (Y) with respect to a direction (X) of the waterway and provided with blades that, by rotating around an axis that is not parallel to the water surface, thrust floating waste towards an area of the waterway (F), creating a narrowing at which said plurality of detector devices and said one or more mechanical devices are installed.

14. The system (100) according to claim 13, wherein said sonar device (2) and/or said camera (3) are oriented in such a way as to examine an the area upstream of said second system (200), and wherein said processing unit is in communication with said second system (200), said second system comprising lifting or moving means configured to remove one or more of said modules (201) from the waterway.

15. The system (100) according to claim 1, wherein said camera (3, 12, 13) is a structured light camera.

16. The system (100) according to claim 1, wherein said system is completely or partially installed on a watercraft.

17. A method for mapping, detecting and identifying waste in a waterway, comprising the steps of:
providing a system according to claim 1;
setting to work said plurality of detector devices, through the presence of any waste in the water, both deep and floating, can be detected;
processing the data collected by said plurality of detector devices in order to:
(a) determine how said waste is distributed in the water; and
(b) identify the type of waste present in the water, distinguishing at least between natural waste and artificial waste.

18. The method according to claim 17, further comprising a step of removing said artificial waste and/or said natural waste by extracting said artificial waste and/or said natural waste from the waterway and/or a step of diverting said artificial waste and/or said natural waste.

19. The method according to claim 17, wherein one or more of said steps are carried out on a watercraft, on which an entirety or a part of the system according to claim 1 is installed.
